(19) United States
(12) Patent Application Publication
(10) Pub. No.: US 2016/0108687 A1
(43) Pub. Date: Apr. 21, 2016

(54) Means and Methods for Multirnodality Analysis and Processing of Drilling Mud

(71) Applicant: Aspect International (2015) Private Limited, Singapore (SG)

(72) Inventor: Uri Rapoport, Chicago, IL (US)

(73) Assignee: Aspect International (2015) Private Limited, Singapore (SG)

(21) Appl. No.: 14/956,448

(22) Filed: Dec. 2, 2015

Related U.S. Application Data
(63) Continuation-in-part of application No. PCT/IL2014/050544, filed on Jun. 16, 2014.
Application No. PCT/IL2014/050544 is a continuation-in-part of application No. 14/571,718, filed on Dec. 16, 2014.

(51) Int. Cl. E21B 21/01; G01V 5/04; E21B 21/06; G01V 5/12; G01V 3/38; G01V 3/32; E21B 49/08; G01N 30/02

(52) U.S. Cl. CPC E21B 21/01; E21B 49/08; G01V 5/04; G01V 5/045; G01N 30/02; G01V 5/12; G01V 3/38; G01V 3/32; E21B 21/065; G01N 2030/025; G01N 2030/027

(57) ABSTRACT

The present application relates to an analysis system for multimodal analysis of drilling mud. Analyzing means, preferably and NMR or MRI device, are disposed about a drilling mud recirculation system and configured to communicate with the recirculation system's control system. The analyzing means are used to determine the value of a predetermined quality parameter Q. If Q fails to meet a predetermined quality criterion, the analysis system instructs the recirculation system to perform an action to alter the properties of the drilling mud such that the drilling mud returning to the drill rig will meet the quality criterion.

### CROSS REFERENCE TO RELATED APPLICATIONS

This application is a continuation-in-part of U.S. patent application Ser. No. 14/571,718, filed 16 Dec. 2014 titled “MEANS AND METHODS FOR MULITMODALITY ANALYSIS AND PROCESSING OF DRILLING MUD” which is a continuation-in-part of International (PCT) Application No. PCT/IL2014/050544, filed 16 Jun. 2014, which claims priority from U.S. Provisional Appl. Nos. 61/837205, filed 20 Jun. 2013, and 61/889,113, filed 10 Oct. 2013. This application also claims priority from U.S. Provisional Appl. Nos. 61/969175, filed 23 Mar. 2014; 61/992,919, filed 14 May 2014; and 62/029,585, filed 28 Jul. 2014. All of these applications are incorporated by reference in their entirety.

### BACKGROUND

1. Field of the Application

The present invention generally pertains to an integrated multimodality system for analyzing and monitoring of drilling mud in drilling mud recycling process and method thereof.

2. Description of Related Art

Drilling muds are very complex fluids used to drill oil wells. Their functions are various: to carry the rock cuttings to the surface, to maintain a sufficient pressure against the rock formation, to lubricate and cool the bit. There are a few families of drilling muds: oil based muds (invert emulsion of brine into an oil phase with various additives) and water based muds (aqueous solutions of clays and polymers). Water-based mud (WBM) is a most basic water-based mud system begins with water, then clays and other chemicals are incorporated into the water to create a homogenous blend resembling something between chocolate milk and a malt (depending on viscosity). The clay (called “shale” in its rock form) is usually a combination of native clays that are suspended in the fluid while drilling, or specific types of clay that are processed and sold as additives for the WBM system. The most common of these is bentonite, frequently referred to in the oilfield as “gel”. Gel likely makes reference to the fact that while the fluid is being pumped, it can be very thin and free-flowing (like chocolate milk), though when pumping is stopped, the static fluid builds a “gel” structure that resists flow. When an adequate pumping force is applied to “break the gel”, flow resumes and the fluid returns to its previously free-flowing state. Many other chemicals (e.g. potassium formate) are added to a WBM system to achieve various effects, including: viscosity control, shale stability, enhance drilling rate of penetration, cooling and lubricating of equipment. Oil-based mud (OBM) can be a mud where the base fluid is a petroleum product such as diesel fuel. Originally prepared from produced oil, oil based muds formulations have evolved to very complex compositions of various additives. The base oil may be of various nature, and additives are very complex: water droplets, surfactants, organophilic clays, viscosifyers, various solids and others. These additives give specific properties to the mud, particularly regarding rheological properties. Oil-based muds are used for many reasons, some being increased lubricity, enhanced shale inhibition, and greater cleaning abilities with less viscosity. Oil-based muds also withstand greater heat without breaking down. The use of oil-based muds has special considerations. These include cost, environmental considerations such as disposal of cuttings in an appropriate place to isolate possible environmental contamination and the exploratory disadvantages of using oil based mud, especially in wildcat wells due inability to analyze oil shows in cuttings, because the oil based mud has fluorescence confusing with the original oil of formation. Therefore induces contamination of cuttings samples, cores, sidewall cores for geochemical analysis of TOO and masks the real determination of API gravity due to this contamination. Synthetic-based fluid (SBM) is a mud where the base fluid is a synthetic oil. This is most often used on offshore rigs because it has the properties of an oil-based mud, but the toxicity of the fluid fumes are much less than an oil-based fluid.

Drilling muds are often described as thixotropic shear thinning fluids with a yield stress. Due to their complex composition, drilling muds exhibit an internal structure which is liable to modify according to the flowing and shear conditions, which may lead to non-homogenous phenomena. It is therefore important to develop investigation techniques allowing visualizing the internal structure of the fluid in parallel to rheological measurements.

On a drilling rig, mud is pumped from the mud pits through the drill string where it sprays out of nozzles on the drill bit, cleaning and cooling the drill bit in the process. The mud then carries the crushed or cut rock (“cuttings”) up the annular space (“annulus”) between the drill string and the sides of the hole being drilled, up through the surface casing, where it emerges back at the surface. Cuttings are then filtered out with either a shale shaker, or the newer shale conveyor technology, and the mud returns to the mud pits. The mud pits let the drilled “fines” settle; the pits are also where the fluid is treated by adding chemicals and other substances.

The returning mud can contain natural gases or other flammable materials which will collect in and around the shale shaker/conveyor area or in other work areas. Because of the risk of a fire or an explosion if they ignite, special monitoring sensors and explosion-proof certified equipment is commonly installed, and workers are advised to take safety precautions. The mud is then pumped back down the borehole and further re-circulated. After testing, the mud is treated periodically in the mud pits to ensure properties which optimize and improve drilling efficiency, borehole stability, and other requirements listed below.

Drilling muds are classified based on their fluid phase, alkalinity, dispersion and the type of chemicals used. Dispersed systems are Freshwater mud—Low pH mud (7.0-9.5) that includes spud, bentonite, natural, phosphate treated muds, organic mud and organic colloid treated mud. High pH mud example alkaline tannate treated muds are above 9.5 in pH. Water based drilling mud that represses hydration and dispersion of clay—There are 4 types: high pH lime muds, low pH gypsum, seawater and saturated salt water muds. Non-dispersed systems are low solids mud—These muds contain less than 3-6% solids by volume and weight less than 9.5 lbs/gal. Most muds of this type are water-based with varying quantities of bentonite and a polymer. Emulsions usually selected from oil in water (oil emulsion muds) and water in oil (invert oil emulsion muds). Oil based muds contain oil as the continuous phase and water as a contaminant, and not an element in the design of the mud. They typically contain less than 5% (by volume) water. Oil-based muds are usually a mixture of diesel fuel and asphalt, however can be based on produced crude oil and mud, see M. G. Prammer, E. Drack, G. et al. 2001. The Magnetic-Resonance While-Drilling Tool: Theory and Operation, SPE Reservoir Evaluation & Engineering 4(4) 72495-PA which is incorporated herein as a reference.

Coussot et al (Oil & Gas Science and Technology—Rev. IFP, Vol. 59 (2004), No. 1, pp. 23-29), presented rheological experiments coupled to magnetic resonance imaging (MRI). Using this technique, they have determined the velocity profile in a viscometric flow. Coussot et at did not disclose or taught use of MRI in returning mud treatment, as be disclosed below.

U.S. Pat. No. 6,268,726 to Numar Corporation discloses an NMR measurement-while-drilling tool having the mechanical strength and measurement sensitivity to perform NMR measurements of an earth formation while drilling a borehole, and a method and apparatus for monitoring the motion of the measuring tool in order to take this motion into account when processing NMR signals from the borehole, is incorporated herein as a reference. U.S. '726 further discloses an apparatus wherein its tool has a permanent magnet with a magnetic field direction substantially perpendicular to the axis of the borehole, a steel collar of a non-magnetic material surrounding the magnet, antenna positioned outside the collar, and a soft magnetic material positioned in a predetermined relationship with the collar and the magnet that helps to shape the magnetic field of the tool. Due to the non-magnetic collar, the tool can withstand the extreme conditions in the borehole environment while the borehole is being drilled. Motion management apparatus and method are employed to identify time periods when the NMR measurements can be taken without the accuracy of the measurement being affected by the motion of the tool or its spatial orientation.

Other patents directed to practical NMR measurements while drilling are U.S. Pat. No. 5,705,927 issued Jan. 6, 1998, to Sezginer et al.; U.S. Pat. No. 5,557,201 issued Sep. 17, 1996, to Kleinberg et al.; and U.S. Pat. No. 5,280,243 issued Jan. 18, 1994, to Miller; U.S. Pat. No. 6,362,619 and U.S. Pat. No. 8,373,412, U.S. Pat. No. 8,143,887 “Apparatus and method for real time and real flow-rate measurement of multi-phase fluids with MRI” by Shell Oil Company (Houston, Tex., herein after '887)—all are incorporated herein as a reference.

Multi-factor authentication (also MFA, two-factor authentication, two-step verification, TFA, T-FA or 2FA) is an approach to authentication which requires the presentation of two or more of the three authentication factors: a knowledge factor (“something only the user knows”), a possession factor (“something only the user has”), and an inherence factor (“something only the user is”). After presentation, each factor must be validated by the other party for authentication to occur.

A public key certificate (also known as a digital certificate or identity certificate) is an electronic document that uses a digital signature to bind a public key with an identity—information such as the name of a person or an organization, the address, and the email address. The certificate can be used to verify that a public key belongs to an individual.

In a typical public-key infrastructure (PKI) scheme, the signature will be of a certificate authority (CA). In a web of trust scheme, the signature is of either the user (a self-signed certificate) or other users (“endorsements”). In either case, the signatures on a certificate are attestations by the certificate signer that the identity information and the public key belong together.

U.S. Pat. No. 6,907,375 (U.S. '375) focuses on oil recovery system diagnostics and analysis and the human interface for comprehension and affirmative reporting of events associated with the optimization of the oil recovery process. The U.S. '375 presents a method for monitoring and analyzing a plurality of signals from monitors on at least one first drilling rig of a plurality of drilling rigs.

A multi-modality analysis system and methods for real-time measurements of drilling muds, especially for monitoring and optimizing the recycling parameters of the drilling mud, including continuous, one-step on-line measurement of mud-related parameters is still a long felt need. Moreover, a further unmet need is a measuring system for defining mud characteristics, such as its fluid phase, alkalinity, dispersion and the type of chemicals to be added in order to optimize and improve drilling efficiency, borehole stability, and other requirements as stated above.

Although great strides have been made in the area of analysis and processing of drilling mud, many shortcomings remain.

### DESCRIPTION OF THE DRAWINGS

FIG. 1 shows an integrated multimodality system for analyzing and monitoring drilling mud recycling process, in accordance with an embodiment of the present invention;

FIG. 2 presents further details of drilling mud recycling line, in accordance with an embodiment of the present invention;

FIG. 3 presents an analysis system operative in connection with a drilling rig according to an embodiment of the invention;

FIG. 4 presents a plurality of analyzing modules (308a-d) configured as an analysis system operative in connection with a drilling rig (mud inflow 305, mud outflow 309) according to an embodiment of the invention;

FIG. 5 presents a plurality of analyzing modules (308a-b) configured “one in the other” configuration as a part of an analysis system operative in connection with a drilling rig (mud inflow 305, mud outflow 309) according to an embodiment of the invention;

FIG. 6 presents an analysis system operative in connection with a drilling rig according to an embodiment of the invention;

FIG. 7 presents an analysis system operative in connection with a drilling rig according to an embodiment of the invention;

FIG. 8 presents an analysis system operative in connection with two drilling rigs (301a and 301b) according to an embodiment of the invention;

FIG. 9 presents a certificating analysis system operative in connection with a drilling rig according to an embodiment of the invention; and

FIG. 10 presents a flowchart of an integrated method for analyzing and monitoring drilling mud recycling process, in accordance with an embodiment of the present invention.

### DETAILED DESCRIPTION OF THE PREFERRED EMBODIMENT

It is thus an object of the invention to disclose an integrated multimodality analysis system (307) for analyzing and monitoring drilling mud recycling process comprising: a. an integrated multimodality analyzing module (308) coupled to a drilling mud recirculation system (12) b. at least one processing module (310) configured to receive in real time at least one result of measurement from said integrated multimodality analyzing module (308), to report in real time said at least one result, to compare in real time said at least one result with an established standard, and to communicate with at least one feedback mechanism for automatic control of at least one step of drilling mud recycling process. Wherein said integrated multimodality analyzing module (308) comprises at least two analyzing means configured to measure independently at least one physical or chemical property of said drilling mud and is configured to measure in real time at least one chemical or physical property of said drilling mud flowing through said drilling mud recirculation system (12).

It is another object of the invention to disclose the multimodality system as defined in any of the above, wherein said analyzing means comprising at least one member of the group consisting of nuclear magnetic resonance (NMR), magnetic resonance imaging (MRI) and any combination thereof.

It is another object of the invention to disclose the multimodality system as defined in any of the above, wherein said analyzing means comprising at least one member of the group consisting of dynamic imaging particle analyzer, gas chromatography (GC), liquid chromatography (LC), high performance liquid chromatography (HPLC), laser diffraction, mass spectrometry (MS), FTIR spectrometry gas analyzer, atomic absorption spectroscopy (AAS), Infrared Spectroscopy (IR), differential scanning calorimetry (DSC), electron paramagnetic resonance (EPR), energy dispersive spectroscopy (EDS), field flow fractionation (FFF), flow injection analysis (FIA), gel permeation chromatography-IR spectroscopy (GPC-IR), Mossbauer spectrometer, ion microprobe (IM), inductively coupled plasma (ICP), ion selective electrode (ISE), laser induced breakdown spectroscopy (LIBS), neutron activation analysis, particle induced X-ray emission spectroscopy (PIXE), pyrolysis gas chromatography mass spectrometry (PY-GC-MS), Raman spectroscopy, refractive index, resonance enhanced multiphoton ionization (REMPI), thermogravimetric Analysis (TGA), X-ray diffraction (XRD), X-ray fluorescence spectroscopy, X-ray microscopy, pressure sensor, differential pressure sensor, salinity sensor, densitometer, CO2 concentration analyzer and any combination thereof.

It is another object of the invention to disclose the multimodality system as defined in any of the above, wherein said analyzing means comprises at least one member of the group consisting of U-tube viscometers, Falling sphere viscometers, Oscillating Piston Viscometer, Vibrational viscometers, Rotational viscometers, Electromagnetically Spinning Sphere, Viscometer, Stabinger viscometer, Bubble viscometer, Micro-Slit Viscometers, Mooney-Line viscometer, NMR/MRI-bases viscometers and any combination thereof.

It is another object of the invention to disclose the multimodality system as defined in any of the above, wherein said analyzing means comprises at least one member of the group consisting of Pipe or Capillary rheometers, Rotational cylinder rheometers, extensional rheometers, Acoustic rheometers, Falling Plate rheometers, Capillary or Contraction Flow rheometers, Oscillating Disc Rheometer (ODR), Moving Die Rheometer (MDR) and any combination thereof.

It is another object of the invention to disclose the multimodality system as defined in any of the above, wherein said at least one physical or chemical property provided by said analyzing means is selected from the group consisting of: specific gravity, density, salinity, rheology parameter, particle size, particle radius, particle size distribution, particle radius distribution, particle shape, particle shape distribution, particle smoothness, particle roughness, particle smoothness to roughness distribution, particle ruggedness, particle gruffness, particle choppedness, particle granulation, particle raggedness, particle raucousness, particle rustication (scabrousness), water content, content of water-immiscible solutions, water to solvent ratio, electrical stability, cation exchange capacity, chloride content in water based mud, water hardness in water based mud, solubility of water based mud, saturation of water based mud, alkalinity, phenophthalein alkalinity of mud filtrate, methyl orange alkalinity end point of mud filtrate, calcium chloride content; gas solubility in oil based mud, chemical composition of formation gas, equivalent circulating density, water phase activity, salinity of said drilling mud, water cut, flow parameters, and any combination thereof.

It is another object of the invention to disclose the multimodality system as defined in any of the above, wherein integrated multimodality analyzing module (308) comprises a plurality of analyzing modules in a configuration chosen from parallel, series, layered, and any combination thereof.

It is another object of the invention to disclose the multimodality system as defined in any of the above, wherein said drilling mud recirculation system (12) comprises: a. a drilling mud recycling unit; b. at least one conduit (24) in fluid communication with said drilling mud recycling unit, said conduit (24) comprises a mud-inflow (68) and a mud-outflow (70) in fluid communication with a drilling rig (301); c. at least one pump (34) for in fluid communication with said conduit (24) configured to produce an internal flow of drilling mud through said conduit (24) from said mud-inflow (68) to said mud-outflow (68).

It is another object of the invention to disclose the multimodality system as defined in any of the above, wherein said integrated multimodality analyzing module (308) is connected with said at least one conduit (24) in one or more ways listed in the group consisting of in line connection, on line connection, next to line connection, side-by-side parallel connection, bypass connection and any combination thereof.

It is another object of the invention to disclose the multimodality system as defined in any of the above, wherein said drilling mud recycling unit comprising at least one member selected from the group consisting of means to restore physical properties of said drilling mud, means to restore chemical properties of said drilling mud, shale shaker, at least one reservoir of drilling mud in closable connection with said internal flow and any combination thereof.

It is another object of the invention to disclose the multimodality system as defined in any of the above, wherein said drilling mud recycling unit recycles said drilling mud via steps selected from the group consisting of adding ingredients and raw materials, mixing, shaking, rotating, tumbling, aerating, heating, cooling, holding at a fixed temperature, emulsifying, adding water or water immiscible solutions, grinding, grounding, milling, shredding, pulverizing, cutting, filtering, reducing particle size, de-emulsifying, kneading, decanting, settling, distilling, decentering, vacuuming and any combination thereof.

It is another object of the invention to disclose the multimodality system as defined in any of the above, wherein said processing module (310) comprising communication component, a non-transitory computer-readable medium and a display.

It is another object of the invention to disclose the multimodality system as defined in any of the above, wherein said feedback mechanism comprises the group consisting of recirculation control system, a receiving station not connected to said recirculation system or any combination thereof.

It is another object of the invention to disclose the multimodality system as defined in any of the above, wherein said feedback mechanism comprises means to alter at least one parameter of operation of said recirculation system selected from a group consisting of addition of at least one ingredient, rate of addition of ingredient, mixing rate, mixing time, ingredient admixing rate, ingredient admixing time, rate of change of mixing rate, shaking rate, shaking time, rate of change of shaking rate, rotation rate, rotation time, rate of change of rotation rate, tumbling rate, tumbling time, rate of change of tumbling rate, aeration rate, aeration time, rate of change of aeration rate, cutting time, cutting rate, rate of change of cutting rate, milling time, milling rate, rate of change of milling rate, heating rate, heating time, rate of change of heating rate, shaking rate, shaking time, rate of change of heating rate, cooling rate, cooling time, rate of change of cooling rate, time held at a constant temperature, emulsification rate, de-emulsification rate, emulsification time, de-emulsification time, rate of change of emulsification rate, kneading rate, kneading time, rate of change of kneading rate, decanting time, decanting rate, rate of change of decanting rate, decantering time, decantering rate, rate of change of decantering rate, and any combination thereof.

It is another object of the invention to disclose the multimodality system as defined in any of the above, wherein said recirculation system further comprising: a. a tank configured to hold spent drilling fluid; b. a density separation device coupled to an outlet of the tank, said density separation device providing an overflow stream and an underflow stream containing denser material than said overflow stream; c. a fluid density control system configured to adjust the density of the spent drilling fluid provided to the density separation device by recirculating a portion of said underflow stream into said tank.

It is another object of the invention to disclose the multimodality system as defined in any of the above, wherein said system generates a mud log, parameters in said mud log selected from a group consisting of: drill rate, particle size, particle shape, particle size distribution, particle shape distribution, lithology of the stratum being drilled, mineralogical description of the stratum being drilled, porosity of the stratum being drilled, mud volume, pump weight, pump pressure, outlet pressure, and any combination thereof.

It is another object of the invention to disclose the multimodality system as defined in any of the above, further comprising a movable platform reversibly connectable to said drilling mud recirculation system.

It is another object of the invention to disclose the multimodality system as defined in any of the above, wherein said multimodality system is portable either in or on a vehicle.

It is another object of the invention to disclose the multimodality system as defined in any of the above, wherein at least one of the following is true: a. at least a part of said drilling mud recirculation system is configured to comply with a NeSSI (new sampling/sensor initiative) specification; b. at least a part of said drilling mud recirculation system is configured to comply with ANSI/ISA SP76.00.2002 miniature, modular mechanical standard specifications; and, c. said drilling mud recirculation system comprises a NeSSI communication bus.

It is another object of the invention to disclose the multimodality system as defined in any of the above, wherein said integrated multimodality analyzing module (308) is configured to generate at least one rheological parameter of said drilling mud from at least one radial velocity profile.

It is another object of the invention to disclose the multimodality system as defined in any of the above, wherein said at least one rheological parameter is selected from a group consisting of radial shear stress parameter σ(r), radial shear rate parameter γ(r), viscosity, viscoelasticity and any combination of thereof.

It is another object of the invention to disclose the multimodality system as defined in any of the above, wherein said processing module (310) determines and evaluates at least one quality test parameter QT of drilling mud according to quality criterion.

It is another object of the invention to disclose the multimodality system as defined in any of the above, wherein said processing module (310) determines and evaluates at least one quality test parameter Q_{T} following steps of: a. defining a quality parameter Q=\sqrt{k²+n²}, where k and n are determined from a relation τ(r)=k[γ(r)]ⁿ, where τ(r) is a radial shear stress of said drilling mud flowing through said conduit and γ(r) is a radial shear rate distribution of said drilling mud flowing through said conduit; b. acquiring a standard quality parameter Q_{S}=\sqrt{k_{S}²+n_{S}²} from analysis of a standardized sample of said drilling mud, said analysis of said standardized sample generating standardized stress parameters k_{S} and n_{S} in the power law equation σ_{S}(r)=k_{S}[γ_{S}(r)]ⁿ^{_{S}} from rheological parameters standardized radial shear stress parameter σ_{S}(r) and standardized radial shear rate parameter γ_{S}(r); c. acquiring a composition quality parameter Q_{C}\sqrt{k_{C}²+n_{C}²} from analysis of a sample of said drilling mud, said analysis of said sample generating composition stress parameters k_{C} and n_{C} in the power law equation σ_{C}(r)=k_{C}[cγ_{C}(r)]ⁿ^{_{C}} from rheological parameters composition radial shear stress parameter σ_{C}(r) and composition radial shear rate parameter γ_{C}(r); d. determining the quality test parameter Q_{T}=|Q_{S}−Q_{C}|.

It is another object of the invention to disclose the multimodality system as defined in any of the above, wherein if said at least one quality test parameter Q_{T} fails to meet said quality criterion, then a. notifying said feedback mechanism via said processing module to activate said recycling unit to perform at least one predetermined action; and b. performing said at least one action until said measured value meets said quality criterion.

It is another object of the invention to disclose the multimodality system as defined in any of the above, wherein said step of performing said at least one predetermined action comprises performing an action selected from the group consisting of: activating said shale shaker; adding water; adding at least one component; filtering said drilling mud; and adjusting a value of at least parameter selected from the group consisting of fluid level, flow rate, pressure, water concentration, concentration of at least one component, rate of addition of at least one component, shaking rate, shaking time, rate of change of shaking rate, rotation rate, rotation time, rate of change of rotation rate, tumbling rate, tumbling time, rate of change of tumbling rate, aeration rate, aeration time, rate of change of aeration rate, cutting time, cutting rate, rate of change of cutting rate, milling time, milling rate, rate of change of milling rate, heating rate, heating time, rate of change of heating rate, rate of change of heating rate, cooling rate, cooling time, rate of change of cooling rate, time held at a constant temperature, emulsification rate, de-emulsification rate, emulsification time, de-emulsification time, rate of change of emulsification rate, kneading rate, kneading time, rate of change of kneading rate, decanting time, decanting rate, rate of change of decanting rate.

It is a further object of the invention to disclose an integrated method for analyzing and monitoring drilling mud recycling process, said method comprises steps of: a. providing an integrated multimodality analyzing module (308) coupled to a drilling mud recirculation system (12); b. providing at least one processing module (310); c. measuring in real time at least one chemical or physical property of drilling mud flowing through said recirculation system (12) using said integrated multimodality analyzing module (308); d. receiving in real time at least one result of said measurement from said integrated multimodality analyzing module (308) via said processing module (310); e. reporting in real time at least one result of said measurement or comparing in real time at least one result of said measurement with an established standard via said processing module (310); and f. communicating via said processing module (310) with at least one feedback mechanism for automatic control of at least one step of drilling mud recycling process. Wherein said integrated multimodality analyzing module (308) comprises at least two analyzing means configured to measure independently at least one physical or chemical property or both of said drilling mud and is configured to measure in real time at least one chemical or physical property of said drilling mud flowing through said drilling mud recirculation system (12).

It is another object of the invention to disclose the integrated method as defined in any of the above, wherein said analyzing means comprising at least one member of the group consisting of nuclear magnetic resonance (NMR), magnetic resonance imaging (MRI) and any combination thereof.

It is another object of the invention to disclose the integrated method as defined in any of the above, wherein said analyzing means comprising at least one member of the group consisting of dynamic imaging particle analyzer, gas chromatography (GC), liquid chromatography (LC), high performance liquid chromatography (HPLC), laser diffraction, mass spectrometry (MS), FTIR spectrometry gas analyzer, atomic absorption spectroscopy (AAS), Infrared Spectroscopy (IR), differential scanning calorimetry (DSC), electron paramagnetic resonance (EPR), energy dispersive spectroscopy (EDS), field flow fractionation (FFF), flow injection analysis (FIA), gel permeation chromatography-IR spectroscopy (GPC-IR), Mossbauer spectrometer, ion microprobe (IM), inductively coupled plasma (ICP), ion selective electrode (ISE), laser induced breakdown spectroscopy (LIBS), neutron activation analysis, particle induced X-ray emission spectroscopy (PIXE), pyrolysis gas chromatography mass spectrometry (PY-GC-MS), Raman spectroscopy, refractive index, resonance enhanced multiphoton ionization (REMPI), thermogravimetric Analysis (TGA), X-ray diffraction (XRD), X-ray fluorescence spectroscopy, X-ray microscopy, pressure sensor, differential pressure sensor, salinity sensor, densitometer, CO2 concentration analyzer and any combination thereof.

It is another object of the invention to disclose the integrated method as defined in any of the above, wherein said analyzing means comprising at least one member of a group consisting of U-tube viscometers, Falling sphere viscometers, Oscillating Piston Viscometer, Vibrational viscometers, Rotational viscometers, Electromagnetically Spinning Sphere, Viscometer, Stabinger viscometer, Bubble viscometer, Micro-Slit Viscometers, Mooney-Line viscometer, NMR/MRI-bases viscometers and any combination thereof.

It is another object of the invention to disclose the integrated method as defined in any of the above, wherein said analyzing means comprising at least one member of a group consisting of Pipe or Capillary rheometers, Rotational cylinder rheometers, extensional rheometers, Acoustic rheometers, Falling Plate rheometers, Capillary/Contraction Flow rheometers, Oscillating Disc Rheometer (ODR), Moving Die Rheometer (MDR) and any combination thereof.

It is another object of the invention to disclose the integrated method as defined in any of the above, wherein said at least one physical or chemical property analyzed by said analyzing means is selected from a group consisting of: specific gravity, density, salinity, rheology parameter, particle size, particle radius, particle size distribution, particle radius distribution, particle shape, particle shape distribution, particle smoothness, particle roughness, particle smoothness to roughness distribution, particle ruggedness, particle gruffness, particle choppedness, particle granulation, particle raggedness, particle raucousness, particle rustication (scabrousness), water content, content of water-immiscible solutions, water to solvent ratio, electrical stability, cation exchange capacity, chloride content in water based mud, water hardness in water based mud, solubility of water based mud, saturation of water based mud, alkalinity, phenophthalein alkalinity of mud filtrate, methyl orange alkalinity end point of mud filtrate, calcium chloride content; gas solubility in oil based mud, chemical composition of formation gas, equivalent circulating density, water phase activity, salinity of said drilling mud, water cut, flow parameters, and any combination thereof.

It is another object of the invention to disclose the integrated method as defined in any of the above, wherein said step of measuring is carried out through said integrated multimodality analyzing module (308) comprising a plurality of analyzing modules in a configuration chosen from parallel, series, layered, and any combination thereof.

It is another object of the invention to disclose the integrated method as defined in any of the above, wherein said recycling system (12) comprises: a. a drilling mud recycling unit; b. at least one conduit (24) in fluid communication with said drilling mud recycling unit, said conduit (24) comprises a mud-inflow (68) and a mud-outflow (70) in fluid communication with a drilling rig (301); and c. at least one pump (34) for in fluid communication with said conduit (24) configured to produce an internal flow of drilling mud through said conduit (24) from said mud-inflow (68) to said mud-outflow (68).

It is another object of the invention to disclose the integrated method as defined in any of the above, wherein said step of measuring is carried out through said integrated multimodality analyzing module (308) connected with said at least one conduit in one or more ways listed in a group consisting of: in line connection, on line connection, next to line connection, side-by-side parallel connection, bypass connection and any combination thereof.

It is another object of the invention to disclose the integrated method as defined in any of the above, wherein said drilling mud recycling unit comprising at least one member selected from the group consisting of means to restore physical properties of said drilling mud, means to restore chemical properties of said drilling mud, shale shaker, at least one reservoir of drilling mud in closable connection with said internal flow and any combination thereof.

It is another object of the invention to disclose the integrated method as defined in any of the above, wherein said drilling mud recycling unit recycles drilling mud via steps selected from a group consisting of: adding ingredients and raw materials, mixing, shaking, rotating, tumbling, aerating, heating, cooling, holding at a fixed temperature, emulsifying, adding water or water immiscible solutions, grinding, grounding, milling, shredding, pulverizing, cutting, filtering, reducing particle size, de-emulsifying, kneading, decanting, settling, distilling, decentering, vacuuming and any combination thereof.

It is another object of the invention to disclose the integrated method as defined in any of the above, wherein said processing module (310) comprising communication component, a non-transitory computer-readable medium and a display.

It is another object of the invention to disclose the integrated method as defined in any of the above, wherein said feedback mechanism comprises the group consisting of recirculation control system, a receiving station not connected to said recirculation system or any combination thereof.

It is another object of the invention to disclose the integrated method as defined in any of the above, wherein said feedback mechanism comprises means to alter at least one parameter of operation of said recirculation system selected from a group consisting of addition of at least one ingredient, rate of addition of ingredient, mixing rate, mixing time, ingredient admixing rate, ingredient admixing time, rate of change of mixing rate, shaking rate, shaking time, rate of change of shaking rate, rotation rate, rotation time, rate of change of rotation rate, tumbling rate, tumbling time, rate of change of tumbling rate, aeration rate, aeration time, rate of change of aeration rate, cutting time, cutting rate, rate of change of cutting rate, milling time, milling rate, rate of change of milling rate, heating rate, heating time, rate of change of heating rate, shaking rate, shaking time, rate of change of heating rate, cooling rate, cooling time, rate of change of cooling rate, time held at a constant temperature, emulsification rate, de-emulsification rate, emulsification time, de-emulsification time, rate of change of emulsification rate, kneading rate, kneading time, rate of change of kneading rate, decanting time, decanting rate, rate of change of decanting rate, decantering time, decantering rate, rate of change of decantering rate, and any combination thereof.

It is another object of the invention to disclose the integrated method as defined in any of the above, wherein said recirculation system further comprising: a. a tank configured to hold spent drilling fluid; b. a density separation device coupled to an outlet of the tank, said density separation device providing an overflow stream and an underflow stream containing denser material than said overflow stream; and c. a fluid density control system configured to adjust the density of the spent drilling fluid provided to the density separation device by recirculating a portion of said underflow stream into said tank.

It is another object of the invention to disclose the integrated method as defined in any of the above, wherein said method generates a mud log, parameters in said mud log selected from a group consisting of: drill rate, particle size, particle shape, particle size distribution, particle shape distribution, lithology of the stratum being drilled, mineralogical description of the stratum being drilled, porosity of the stratum being drilled, mud volume, pump weight, pump pressure, outlet pressure, and any combination thereof.

It is another object of the invention to disclose the integrated method as defined in any of the above, wherein at least one of the following is true: a. at least a part of said drilling mud recirculation system is configured to comply with a NeSSI specification; b. at least a part of said drilling mud recirculation system is configured to comply with ANSI/ISA SP76.00.2002 miniature, modular mechanical standard specifications; and c. said drilling mud recirculation system comprises a NeSSI communication bus.

It is another object of the invention to disclose the integrated method as defined in any of the above, wherein said step of measuring is carried out through said integrated multimodality analyzing module (308) configured to generate at least one rheological parameter of said drilling mud from at least one radial velocity profile.

It is another object of the invention to disclose the integrated method as defined in any of the above, wherein said at least one rheological parameter is selected from a group consisting of radial shear stress parameter σ(r), radial shear rate parameter γ(r), viscosity, viscoelasticity and any combination of thereof.

It is another object of the invention to disclose the integrated method as defined in any of the above, wherein at least one quality test parameter Q_{T} of drilling mud is determined and evaluated according to quality criterion.

It is another object of the invention to disclose the integrated method as defined in any of the above, wherein said at least one quality test parameter is determined following steps of: a. defining a quality parameter Q=\sqrt{k²+n²}, where k and n are determined from a relation τ(r)=k[γ(r)]ⁿ, where τ(r) is a radial shear stress of said drilling mud flowing through said conduit and γ(r) is a radial shear rate distribution of said drilling mud flowing through said conduit; and b. acquiring a standard quality parameter Q_{S}=\sqrt{k_{S}²+n_{S}²} from analysis of a standardized sample of said drilling mud, said analysis of said standardized sample generating standardized stress parameters k_{S} and n_{S} in the power law equation σ_{S}(r)=k_{S}[γ_{S}(r)]ⁿ^{_{S}} from rheological parameters standardized radial shear stress parameter σ_{S}(r) and standardized radial shear rate parameter γ_{S}(r); c. acquiring a composition quality parameter Q_{C}=\sqrt{k_{C}²+n_{C}²} from analysis of a sample of said drilling mud, said analysis of said sample generating composition stress parameters k_{C} and n_{C} in the power law equation σ_{C}(r)=k_{C}[γ_{C}(r)]ⁿ^{_{C}} from rheological parameters composition radial shear stress parameter σ_{C}(r) and composition radial shear rate parameter γ_{C}(r); d. determining the quality test parameter Q_{T}=|Q_{S}−Q_{C}|.

It is another object of the invention to disclose the integrated method as defined in any of the above, wherein if said at least one quality test parameter Q_{T} fails to meet said quality criterion, then said method comprises additional steps of: a. notifying said recirculation control system via said processing module to activate said recycling unit to perform at least one predetermined action; and b. performing said at least one action until said measured value meets said quality criterion.

It is another object of the invention to disclose the integrated method as defined in any of the above, wherein said step of performing said at least one predetermined action comprises performing an action selected from the group consisting of: activating said shale shaker; adding water; adding at least one component; filtering said drilling mud; and adjusting a value of at least parameter selected from the group consisting of fluid level, flow rate, pressure, water concentration, concentration of at least one component, rate of addition of at least one component, shaking rate, shaking time, rate of change of shaking rate, rotation rate, rotation time, rate of change of rotation rate, tumbling rate, tumbling time, rate of change of tumbling rate, aeration rate, aeration time, rate of change of aeration rate, cutting time, cutting rate, rate of change of cutting rate, milling time, milling rate, rate of change of milling rate, heating rate, heating time, rate of change of heating rate, rate of change of heating rate, cooling rate, cooling time, rate of change of cooling rate, time held at a constant temperature, emulsification rate, de-emulsification rate, emulsification time, de-emulsification time, rate of change of emulsification rate, kneading rate, kneading time, rate of change of kneading rate, decanting time, decanting rate, rate of change of decanting rate.

It is a further object of the invention to disclose a method of analyzing drilling parameters comprising: a. at least one step of analyzing comprising imaging and timing a series of NMR/MRI images of drilling mud before mud's re-used in a drilling hole (T_{influx}); b. either continuously of batch-wise flowing said time-resolved imaged drilling mud within said drilling hole whilst drilling said hole; c. after flowing period, at least one step of imaging and timing a series of NMR/MRI images of drilling mud after the use in a drilling hole (T_{outflow}); and d. comparing at least one parameter of said inflowing mud (timed at T_{influx}) and said outflowing mud timed (timed at T_{outflow}); thereby defining the change of said parameter and analyzing parameters related with the drilling.

It is a further object of the invention to disclose a method of analyzing drilled products comprising: a. at least one step of analyzing comprising imaging and timing a series of NMR/MRI images of drilling mud before mud's re-used in a drilling hole (T_{influx}); b. either continuously of batch-wise flowing said time-resolved imaged drilling mud within said drilling hole whilst drilling said hole, thereby providing said drilling mud as a flowing carrier of the drilled product; c. after flowing period, at least one step of imaging and timing a series of NMR/MRI images of drilling mud after the use in a drilling hole (T_{outflow}); and d. comparing at least one parameter of said inflowing mud (timed at T_{influx}) and said outflowing mud timed (timed at T_{outflow}); thereby defining the change of said parameter and analyzing said drilled product.

It is a further object of the invention to disclose the method of analyzing drilling parameters or drilled products as defined as any of the above, wherein said step of comparing at least one parameter of said inflowing mud (timed at T_{influx}) and said outflowing mud timed (timed at T_{outflow}) further comprising step of measuring the relaxation time T₁, T₂ and diffusion coefficient D.

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest interpretation of said claims.

The term “magnetic resonance device” (MRD) refers generically to any device, spectrometer, or other apparatus that uses magnetic resonance to obtain information about the composition or physical properties of a sample. Non-limiting examples of MRDs according to this definition include nuclear magnetic resonance (NMR) spectrometers, magnetic resonance imaging (MRI) apparatus, NQR spectrometers, and EPR spectrometers.

The term “ingredient” hereinafter refers to a component of drilling mud. The ingredient can comprise a predetermined composition such as, but not limited to, a proprietary drilling mud component such as a drill pipe corrosion inhibitor, a drilling mud material such as, but not limited to, an oil, or a raw material such as a clay or water.

As used herein, the term “quality parameter” refers to any measured, derived, or calculated parameter that can be used to assess the condition or quality of drilling mud by comparison with a standard value. Quality parameters can include measured values of chemical or physical properties of the drilling mud, or quantities derived or calculated from the measured values of chemical or physical properties of the drilling mud.

The term “instrument” refers to any means for measuring physical or chemical properties of a substance. Thus, a single physical device that measures two different properties or that comprises two modes of measurement would be considered to comprise two different “instruments” as the term is used herein. Any means known in the art for applying these techniques to measurement of physical and/or chemical properties of drilling mud may be used.

In some embodiments, the mud recycling system interfaces between the mud pits and drill string of the drilling system and the magnetic resonance device, which generates magnetic resonance images of the flow, from which rheological parameters of the drilling mud are determined. The component processing system fulfills the New Sensors/Sampling Initiative (NeSSI) protocols and requirements.

In the present invention, recent developments in industrial process improvement initiatives are adopted such as incorporating an on-line testing and adjusting system for iteratively adjusting the drilling mud's characteristics. Another recent development incorporated in the present invention is the integration of sensing devices and monitoring processes into the sampling system. The mechanism preferably adopted is the NeSSI.

The NeSSI requirements fulfill the ANSI/ISA SP76.00.2002 miniature, modular mechanical standard and include mechanical systems associated with the fluid handling components. The ANSI/ISA standard is referenced by the International Electrotechnical Commission in publication IEC 62339-1:2006. Preferably, the present invention incorporates mechanical designs based on the ANSI/ISA SP76.00.02-2002 Standard and, further, preferably at least portions of the drilling system use mechanical designs based on the ANSI/ISA SP76.00.02-2002 Standard.

The NeSSI platform is a miniaturized, modular version of traditional sample gathering and handling methodologies, thus permitting the addition of components as standard modules, and the integration of the sensing system with the sampling system to form a single stand-alone unit for sample extraction and measurement. Using the NeSSI platform, the need for process corrections such as, but not limited to, alterations in the mud characteristics, may be detected earlier in the mud treatment system, thereby improving drilling rates and increasing safety.

The Magnetic Resonance Device (MRD) of Aspect Imaging Ltd (IL and US) is typically useful for the drilling mud analysis, especially, as in the present invention, for managing mud characteristics. The MRD is a relatively small nuclear magnetic resonance device with about 1 Tesla magnetic field, on the order of 0.5 m×0.5 m×1 m in size. Thus, the MRD device is ideal for incorporating in an on-line system, especially in a drilling mud recycling line.

The radial shear stress distribution τ(r) is determined from

$$τ ( r ) = - \frac{Δ P ( r )}{2 L} r$$

where ΔP(r) is the pressure difference between the entrance port and the exit port of the MRD at radial location r. Pressure sensors are located in proximity to the entrance and exit ports and the pressure sensors measure an axial pressure profile P(r), as is known in the art. The pressure sensors are separated by a distance L.

The radial shear rate γ(r) distribution is determined from

$$\dot{γ} ( r ) = \frac{d v ( r )}{d r}$$

where v(r) is the radial velocity profile.

The NMR images, the radial velocity profiles v(r), the pressure profiles P(r), the distance L, and the rheological parameters τ(r) and γ(r) can be stored in a database and can be retrieved from the database as required.

According to a power law distribution for the radial shear stress τ(r), the radial shear stress τ(r) and the radial shear rate γ(r) are related:

τ(r)=k[γ(r)]ⁿ

where k and n are the power law stress parameters.

Typically, the parameters k and n are determined by fitting an averaged radial shear rate distribution γ(r) and an averaged shear stress distribution τ(r) for the radial values r to the power law distribution in equation (3).

A useful quality parameter, Q, is

Q=\sqrt{k²+n²}

where k and n are found by fitting the averaged radial shear rate distribution γ(r) and the averaged shear stress distribution τ(r) for the radial values r to the power law distribution in equation (3).

In preferred embodiments, a composition quality parameter, Q_{C}, is compared to a standard quality parameter, Q_{S}, where Q_{C} is

Q_{C}=\sqrt{k_{C}²+n_{C}²}

and Q_{S} is

Q_{S}=\sqrt{k_{S}²+n_{S}²}

In order to determine whether the sample fulfills the criteria, a quality test parameter Q_{T} is compared to a quality criterion δ and the sample is acceptable if Q_{T}<δ.

In one embodiment, Q_{T}=|Q_{S}−Q_{C}|, and the quality criterion is one standard deviation of the standard quality parameter Q_{S}.

In embodiments where the quality criterion δ is one standard deviation of the standard quality parameter Q_{S}, the standard quality parameter Q_{S} is measured for a plurality of standardized samples of the composition and a standard quality parameter Q_{S,i} is determined for each sample i. The standard deviation, σ_{d}, of the standard quality parameter Q_{S} is found, as is known in the art, from the equation

$${σ}_{d} = \sqrt{\frac{1}{N - 1} {\sum }_{i = 1}^{N} {( {Q}_{S , i} - {Q}_{S} )}^{2}}$$

where Q_{S,i} is the standard quality parameter for the ith standardized sample of the product, N is the number of standardized samples tested, and Q_{S} is the mean of the standard quality parameters Q_{S,i},

In other embodiments, the quality criterion is two standard deviations (95%) of the standard quality parameter Q_{S}. In yet other embodiments, 3 or 4 standard deviations, or even more, are used as a quality criterion.

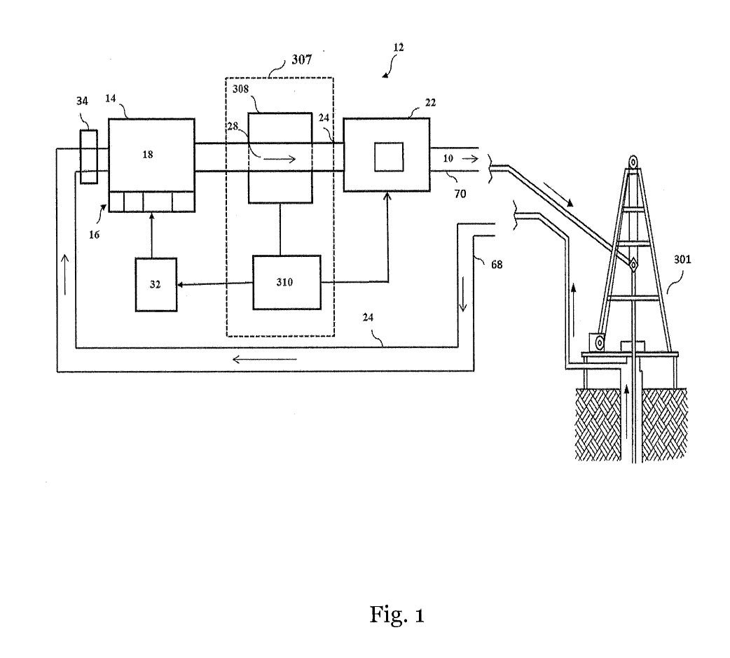

Reference is now made to FIG. 1, which shows an embodiment of the system. In this embodiment, the drilling mud 10 is recycled drilling mud from a drilling rig 301 through a drilling mud recycling system 12. The drilling mud recycling system 12 comprises a component supply device 32 which stores and supplies, on demand drilling mud materials and raw materials, a drilling mud mixing vat system 14, a flow conduit 24, and drilling mud recycling equipment 22. During operation of the drilling mud recycling system, a plurality of components 16 as described hereinafter are injected into the mixing vat system 14, where they combine with recycled mud and are mixed until they form a composition 18 from recycled drilling mud and components. The composition 18 is then injected via conduit 24 into drilling mud recycling equipment 22 and drilling mud 10 is produced in drilling mud recycling equipment 22. The integrated multimodality system 307 is used for analyzing and monitoring drilling mud recycling process. The integrated multimodality system 307 comprises an integrated multimodality analyzing module 308 coupled to a drilling mud recirculation system 12 configured to measure in real time at least one chemical or physical property of drilling mud flowing through said recirculation system 12 and a processing module 310 configured to receive in real time at least one result of measurement from said integrated multimodality analyzing module 308, to report in real time said at least one result, to compare in real time said at least one measurement result with an established standard, and to communicate with at least one feedback mechanism for automatic control of at least one step of drilling mud recycling process. The integrated multimodality analyzing module 308 comprises at least two analyzing means configured to measure independently at least one physical or chemical property or both of said drilling mud and is configured to measure in real time at least one chemical or physical property of said drilling mud flowing through said drilling mud recirculation system 12.

The integrated multimodality system 307 monitors the process in situ, on line and in real time. A sample of composition 18 is injected into flow conduit 24, such that an integrated multimodality analyzing module 308 measures at least one physical and/or chemical property of the composition 18 flowing through the conduit 24. The processing system 310 processes the measured result of the sample of the composition 18 to generate a quality test parameter Q_{T}, of the composition 18, as described below. The quality test parameter Q_{T} is compared to a predetermined check value Q_{C}, as described below, and if the difference is greater than a predetermined amount, the raw material supply device 32 is instructed to supply a predetermined amount of at least one raw material 16 to mixing vat system 14. When the raw material 16 has been incorporated into composition 18, another sample of composition 18 is injected into flow conduit 24, another at least one magnetic resonance image is generated, and the process is repeated iteratively until the quality test parameter Q_{T} differs from the predetermined check value Q_{C} by less than the predetermined amount. In a batch system, the process will terminate when mixing vat system 14 is empty, although no adjustments to the composition 18 are expected to be necessary after an acceptable composition has been attained, and the process will recommence when mixing vat system 14 has been refilled with recycled mud and a new batch of composition 18 has been produced. In a continuous process, there is continuous injection of drilling mud into mixing vat system 14, so that the contents of mixing vat system 14 are constantly being replenished.

In preferred embodiments, the drilling mud recycling system 30 is configured to comply with ANSI/ISA SP76.00.2002 miniature, modular mechanical standard specifications.

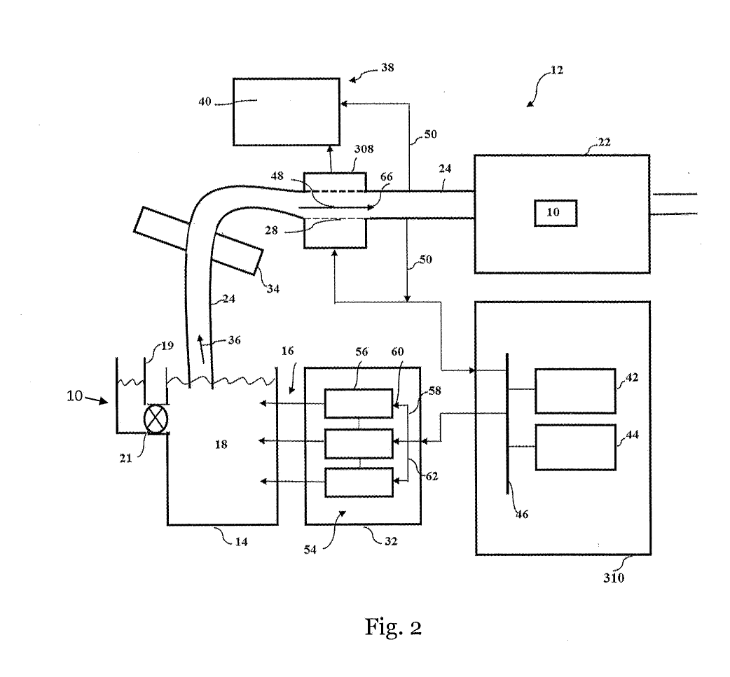

Reference is now made to FIG. 2, which presents further details of the drilling mud recycling system 12, in accordance with a preferred embodiment of the present invention. As shown in FIG. 2, the drilling mud recycling system 12 comprises a vat 14, a batch manifold 19 and control valve 21, a pump 34, a conduit 24, and drilling mud recycling equipment 22. It further comprises a raw material processing system 310 and a raw material supply device 32.

The raw material processing system 310 comprises a processor 42, a memory unit 44 and a communications bus 46, such as a NeSSI communications bus, enabling communications between all parts of the system.

The raw material processing system 310 communicates with the raw material supply device 32 by means of a communications line 52. The raw material supply device 32 comprises a plurality of N raw material reservoirs 54. Typically, each reservoir 56 contains at least one raw material, Iᵢ₌ⱼ. Each reservoir 56 includes a communications port 60, through which each reservoir 56 communicates with the communications line 52 via an internal communication bus 62.

In some embodiments, at least one reservoir 56 contains a mixture of at least two components, I_{i=j, i=m}.

A batch of a sample of the drilling mud 10 is input into the vat 14 from a batch manifold 19 via a control valve 21. A pump 34 pumps the composition 18 of the sample from the vat 14 to the production line 22 via nuclear magnetic imaging device 26. A drilling mud flow 36 flows through the conduit 24. At least a portion, 48, of flow 36 passes through at least a portion of nuclear magnetic imaging device 26, between entrance port 64 and exit port 66. The integrated multimodality analyzing module 308, which can be an NMR device and is transportable on a vehicle, generates at least one magnetic resonance image 38 of the portion 48 of drilling mud flow 36 within the NMR device as a function of a radial location r, as is known in the art. The at least one magnetic resonance image 38 is processed by processor 42 to determine at least one radial velocity profile, v(r), 40 of the composition 18, where the radial parameter r is measured from the center of the conduit 24, such that r=0 is the center of the conduit 24 and r=R is the edge of the flow 36. The at least one magnetic resonance image 38 is transferred to the processor 42 via communication line 50 and communication bus 46. In some embodiments, communication line 50 comprises part of communication bus 46.

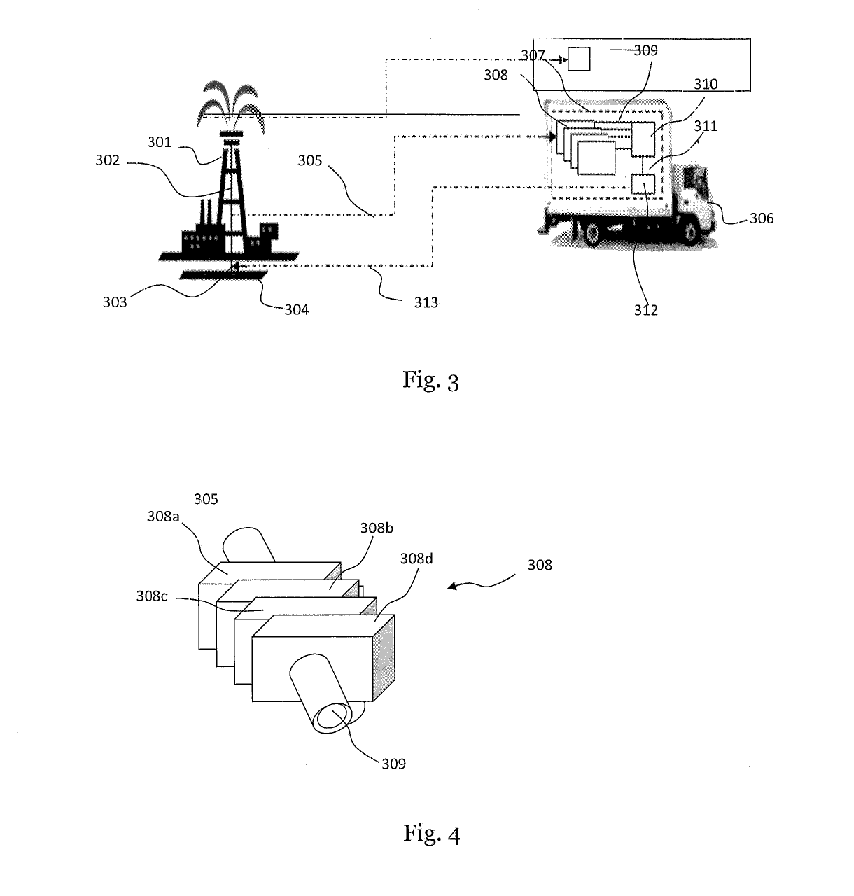

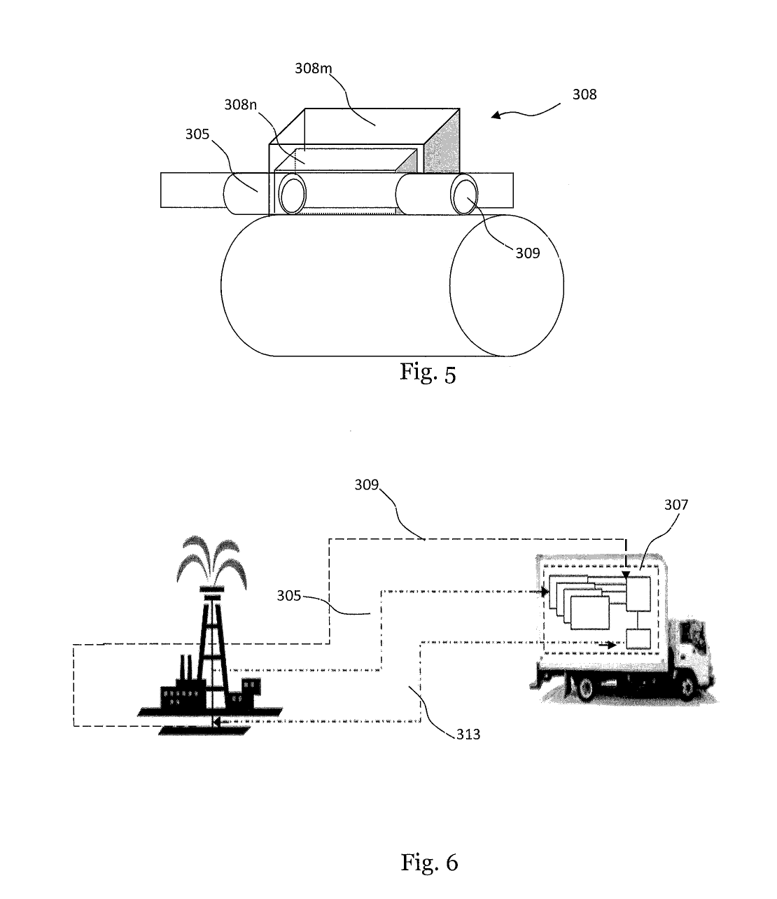

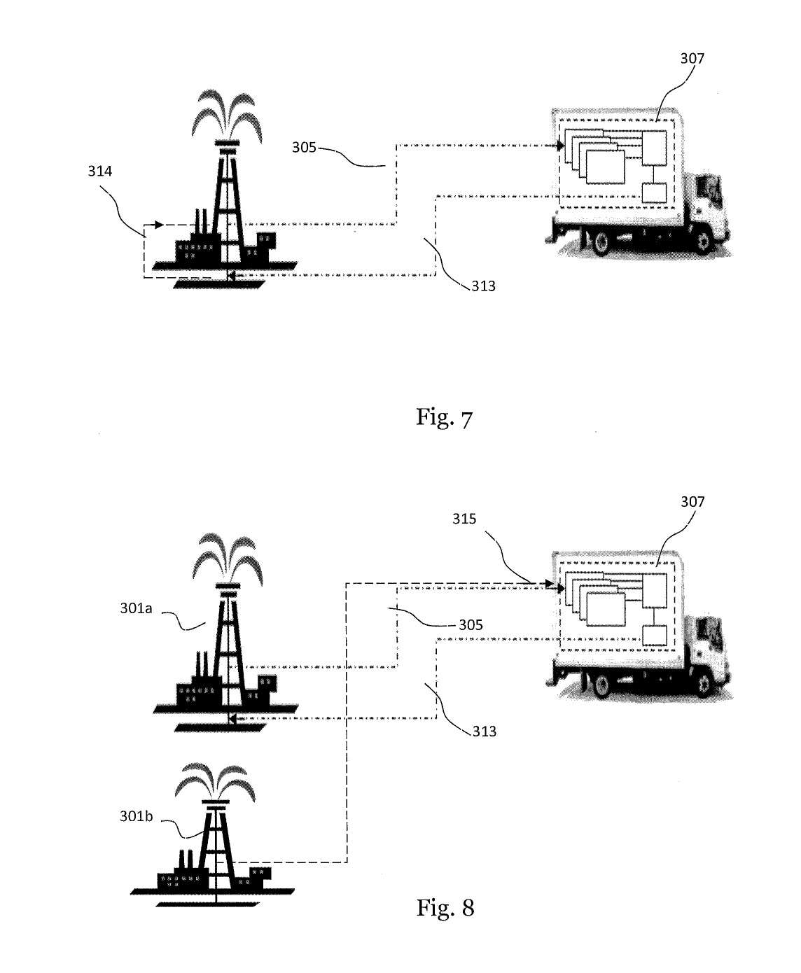

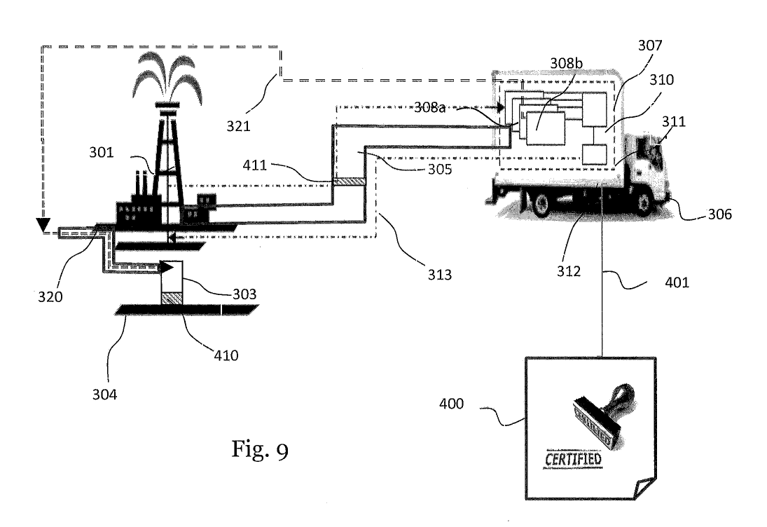

Reference is now briefly made to the following figures, wherein to FIG. 3 which presents an integrated multimodality system 307 in connection with a drilling rig 301 via communication line 305. The integrated multimodality system 307 is transportable via vehicle 306. It feedbackly controls the drilling mud recycling process via communication line 313. FIG. 4 which presents a plurality of analyzing modules (308a-d) configured as an analysis system operative in connection with a drilling rig (mud inflow 305, mud outflow 309) according to an embodiment of the invention. FIG. 5 presents a plurality of analyzing modules (308a-b) configured in a “one inside the other” configuration as a part of an analysis system operative in connection with a drilling rig (mud inflow 305, mud outflow 309) according to an embodiment of the invention. FIG. 6 presents an analysis system operative in connection with a drilling rig according to an embodiment of the invention, with the inflow to the analysis system (307) fluidly connectable to the outgoing recycled drilling mud sampling outlet (305), the outflow of the analysis system (309) fluidly connectable to the drilling rig (301), and a communication line (313) between the rig and the analysis system for control of the mud quality. FIG. 7 presents an analysis system operative in connection with a drilling rig according to an embodiment of the invention with the inflow to the analysis system (307) fluidly connectable to the outgoing recycled drilling mud sampling outlet (305), and a communication line (313) between the rig and the analysis system for control of the mud quality where a further communication line (314) enables feedback control of the drilling mud. FIG. 8 presents an analysis system operative in connection with two drilling rigs (301a and 301b) according to an embodiment of the invention where there are two inlets to the analysis system (305 and 315, respectively) and a communication line (313) between the rig and the analysis system for control of the mud quality; and FIG. 9 presents a certificating analysis system operative in connection with a drilling rig according to an embodiment of the invention. More details and examples are provided below.

Reference is now made to FIG. 9. In the embodiment illustrated in the figure, the analysis system (307) provides a time-resolved analysis of drilling mud, the drilling process and drilling products. A first analyzing module 307 is disposed upstream of the borehole at position 320 to obtain a profile of drilling mud entering the borehole, and a second analyzing module is placed downstream of the borehole (305), to obtain a profile of drilling mud exiting the borehole. If the flow rate R_{f} and the distance between the two analyzing means L are known, then the time it takes for the drilling mud to traverse the distance between them Δt_{f} is easily calculated as L/R_{f}. By timing the measurements made by the two analyzing modules, a time-resolved multi-layered profile (Pt, 400) of said mud sample can be obtained. The time-resolved profile can be obtained under continuous conditions by correlating measurements made by the second analyzing module Δt_{f} after measurements made by the first analyzing module, or in batch mode by using the first analyzing module to make a measurement at time t and the second analyzing module to make a measurement at time t+Δt_{f}. It is also possible to obtain a multi-layer profile if the second measurement is made at a time t+Δt_{f}+δ (δ can be negative) after the first measurement. This multi-layer profile can thus take into account parts of the flow that have reached differing levels of the borehole.

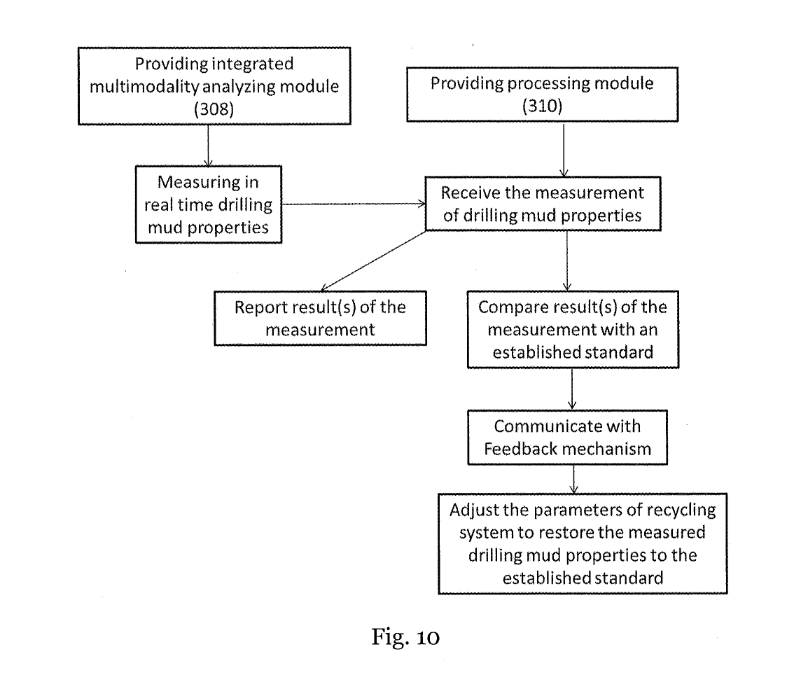

Reference is now made to FIG. 10. In the embodiment illustrated in the figure, the integrated method for analyzing and monitoring drilling mud recycling process comprises steps of: a. providing an integrated multimodality analyzing module (308) coupled to a drilling mud recirculation system (12) b. providing processing module 310; c. the integrated multimodality analyzing module 308 measures at least one physical or chemical property of drilling mud flowing in the recirculation system in real time; d. measured result of at least one physical or chemical property of the drilling mud is received by the procession module 310; e. the processing module 310 reports in real time the results of measurement; or f. the processing module 310 compares the measured result with an established standard; g. if the measured result is beyond the standard deviation of the established standard then the processing module 310 communicates with feedback mechanism to adjust the parameters of the recycling system to restore the drilling mud properties to the established standard.

As said above, drilling mud is used to control subsurface pressures, lubricate the drill bit, stabilize the well bore, and carry the cuttings to the surface, among other functions. As the drill bit grinds rocks into drill cuttings, these cuttings become entrained in the mud flow and are carried to the surface. In order to return the mud to the recirculating mud system and to make the solids easier to handle, the solids must be separated from the mud.

It is thus according to one embodiment of the invention, wherein the following system is provided useful: in order to recycle drilling mud, solids control equipment are used, and a typical four stage solids control equipment used. In a first stage: A shale shaker is utilized: according to rig size, 1 to 3 sets of shale shakers will be used at the first stage solids control separation, e.g., this is done with API 4-0 60 shaker screens. Cuttings over 400 μm are separated in this stage. Then a desander and desilter are used as the second and third stage separation. A mud cleaner is utilized for these stages. It is a combination of shake shaker, desander and desilter. For smaller size rigs (usually under 750 hp), mud treated by shale shaker and mud cleaner can be used for drilling. Under some conditions, such as when the drilling depth is large and a high standard mud is requested, a decantering centrifuge will be used as fourth stage separation. When finer solids are to be separated, for example, for gas cut drilling mud, a vacuum degasser, a mud/gas separator (poor boy degasser) and ignition device will be used.

In parallel to the said mud-recycling scheme, an NMR/MRI-analysis system is integrally utilized to improve the recycling of the used drilling mud and to restore its characteristics to a predefined scale of characteristics, by following the following scheme: (i) defining parameters and values of optimal drilling mud; (ii) on-line and in situ analyzing parameters and values of used drilling mud, preferably, yet not exclusively, during the initial stages of the recycle, when the drilling mud exits from the drilling hole; (iii) comparing said optimal parameters and values and said on-line acquired parameters and values, namely determining the differences between those predefined parameters and value of the ‘optimal drilling mud’ and corresponding parameters and value of the ‘actual drilling mud’, thereby defining which recycle step is required, and further defining parameters and values; such as recycling temperature, operation time of each of the recycling steps, type and quantity of components to admix with said mud, admixing parameters etc, wherein the components can be selected from water, bentonite and the like, calcium containing salts and compositions thereof, surfactant (anionic, cationic or zwitterionic surfactants, for example), fresh drilling mud, water immiscible solutions etc. (iv) recycling the used drilling mud whilst continuously NMR/MRI analyzing its properties, thus on-line feedbacking the recycling system, until the characteristics of the recycled drilling mud equal (plus or minus an allowable predefined measure) the stored characteristics of the ‘optimal drilling mud’. Thus, this novel NMR/MRI-drilling mud recycling integrated-system provides on-line, in-situ, one-continuous-step drilling where an optimal drilling mud is utilized, namely a drilling mud having predefined characteristics, such as rheological characteristics, fluid phase characteristics, alkalinity (calcium content and the like), dispersion characteristics and so on.

The use of NMR as a method for drill logging is well-known in the art. For example, European Pat. No. EP0835463 discloses an NMR logging method that is based on the differing values of the spin-lattice relaxation time T1, the lattice relaxation time T2, and the diffusion constant D for oil and water.

Thus, according to one embodiment of the invention, a time resolved or non-time resolved method of analyzing drilling parameters is provided, especially useful, in the integrated NMR/MRI drilling mud recycling system disclosed above. The method comprises, inter alia, the following steps: at least one step of imaging and timing a series of NMR/MRI images of drilling mud before the mud is re-used in a drilling hole (T_{influx}); either continuously or batch-wise flowing said time-resolved imaged drilling mud within said drilling hole whilst drilling said hole; after the flowing period, i.e., after the length of time between the drilling mud's influx and its outflow from the hole, at least one step of imaging and timing a series of NMR/MRI images of drilling mud after its use in a drilling hole (T_{outflow}); comparing at least one parameter of said inflowing mud (timed at T_{influx}) and said outflowing mud (timed at T_{outflow}); thereby defining the change of said parameter and analyzing parameters related with the drilling: such as debris shape and size, particle distribution and smoothness etc.

According to another embodiment of the invention, a similar method of analyzing drilled product is presented. This method comprises, inter alia, the following steps: at least one step of imaging and timing a series of NMR/MRI images of drilling mud before the mud's re-use in a drilling hole (T_{influx}); either continuously or batch-wise flowing said time-resolved imaged drilling mud within said drilling hole whilst drilling said hole, thereby providing said drilling mud as a flowing carrier of the drilled product: such as solid ground, earth samples, water oil, gas, ores, coal etc); after the flowing period, i.e., the length of time between the drilling mud's influx and its outflow from the hole, generating at least one image of the drilling mud after its use in a drilling hole (T_{outflow}); and then comparing at least one parameter of said inflowing mud (timed at T_{influx}) and said outflowing mud (timed at T_{outflow}); thereby defining the change of said parameter and analyzing said drilled product.

In these methods, the aforesaid step of comparing at least one parameter of said inflowing mud (timed at T_{influx}) and said outflowing mud (timed at T_{outflow}) may further comprise a step of measuring the relaxation times T1, T2 and the diffusion coefficient D as discussed above and a step of imaging and timing a series of NMR/MRI images of drilling mud, either timed at T_{influx}, timed at T_{outflow}, or both.

It is well within the scope of the invention wherein a novel analysis system for analysis and treatment of drilling mud is provided. The analysis system comprises, inter alia, an outgoing recycled drilling mud sampling outlet (see for example member 305 in FIG. 3) connected to a drilling rig (301); and an analysis system (307) coupled to said outlet, configured, by means of a plurality of analyzing modules (e.g., 308), to provide a time resolved multi-layered profile of said mud sample.

According to one embodiment of the technology herein presented, the aforesaid analysis system comprises a viscometer for determining apparent viscosity; plastic viscosity (PV), which is the resistance of fluid to flow; yield point (YP), which is the resistance of initial flow of fluid or the stress required in order to move the fluid; and yield point of bentonite drilling muds.

Additionally or alternatively, and according to yet another embodiment of the technology herein presented, the aforesaid analysis system comprises at least one of the following: thermometer, carbon dioxide analyzing means, such as an FTIR spectrometry gas analyzer; atomic absorption spectroscopy (AAS), atomic emission spectroscopy (AES), atomic fluorescence spectroscopy (AFS), alpha particle X-ray spectrometer (APXS), capillary electrophoresis (CE), chromatography, colorimetry, computed tomography, cyclic voltammetry (CV), differential scanning calorimetry (DSC), electron paramagnetic resonance (EPR, ESR), energy dispersive spectroscopy (EDS/EDX), field flow fractionation (FFF), flow injection analysis (FIA), gas chromatography (GC), gas chromatography-mass spectrometry (GC-MS), gas chromatography-IR spectroscopy (GC-IR), gel permeation chromatography-IR spectroscopy (GPC-IR), high performance liquid chromatography (HPLC), high performance liquid chromatography-IR spectroscopy (HPLC-IR), ion Microprobe (IM), inductively coupled plasma (ICP), ion selective electrode (ISE), laser induced breakdown spectroscopy (LIBS), liquid chromatography-IR spectroscopy (LC-IR), liquid chromatography-mass spectrometry (LC-MS), mass spectrometry (MS), Mössbauer spectroscopy, neutron activation analysis, nuclear magnetic resonance (NMR), particle induced X-ray emission spectroscopy (PIXE), pyrolysis gas chromatography mass spectrometry (PY-GC-MS), Raman spectroscopy, refractive index measurement, resonance enhanced multiphoton ionization (REMPI), transmission electron microscopy (TEM), thermogravimetric Analysis (TGA), X-ray diffraction (XRD), X-ray fluorescence spectroscopy (XRF), X-ray microscopy (XRM), automatic or semi-automatic titrators, e.g., for chloride analysis by titration with a silver nitrate solution, for e.g., Mg⁺² analysis by titration with standard Vesenate solution, and any combination thereof.

Additionally or alternatively, and according to yet another embodiment of the technology herein presented, the aforesaid analysis system comprises at least one of the following: flow meters, such as mechanical flow meters, e.g., piston meter/rotary piston, gear meter, oval gear meter, helical gear, nutating disk meter, variable area meter, turbine flow meter, Woltmann meter, single jet meter, paddle wheel meter, multiple jet meter, Pelton wheel, current meter, pressure-based meters, such as Venturi meter, orifice plate, Dall tube, Pitot tube, multi-hole pressure probe, cone meters, optical flow meters, open channel flow measurement (level to flow, area/velocity), dye testing, acoustic Doppler velocimetry, thermal mass flow meters, including the MAF sensor, vortex flow meters, electromagnetic, ultrasonic and coriolis flow meters, e.g., magnetic flow meters, non-contact electromagnetic flow meters, ultrasonic flow meters (Doppler, transit time), coriolis flow meters etc., laser doppler flow measurement and any combination thereof.

Additionally or alternatively, and according to yet another embodiment of the technology herein presented, the aforesaid analysis system comprises at least one of the following: U-tube viscometers, falling sphere viscometers, oscillating piston viscometer, vibrational viscometers, rotational viscometers, electromagnetically spinning sphere viscometer (EMS viscometer), Stabinger viscometer, bubble viscometer, micro-slit viscometers, Mooney-Line viscometer, NMR/MRI-bases viscometers and any combination thereof.

Additionally or alternatively, and according to yet another embodiment of the technology herein presented, the aforesaid analysis system comprises at least one of the following: pipe or capillary rheometers, rotational cylinder rheometers (cone and plate, linear shear etc), extensional rheometers (Rheotens, CaBER, FiSER, Sentmanat etc.), and other types of extensional rheometers: acoustic rheometers, falling plate rheometers, capillary/contraction flow rheometers, oscillating disc rheometer (ODR), moving die rheometer (MDR), other types of rheometer, and any combination thereof.

Additionally or alternatively, and according to yet another embodiment of the technology herein presented, the aforesaid analysis system comprises an electrical stability tester (EST), such as the Fann 23D available from Fann Instrument Company in Houston, Tex., which is typically used to characterize invert emulsion oil-based drilling fluids.

The thermometer is utilizable e.g., for indirect indications: in water-based mud, the yield point increases with following items: high temperature, the yield point (YP) tends to increase with temperature in water-based mud; contaminants such as carbon dioxide, salt, and anhydrite in the drilling fluids; over treatment of the drilling mud with lime or caustic soda. In oil-based mud, the causes of increasing in YP are as follows: drill solids—the more drill solids, the higher the YP; treatment CO₂ in a mud with lime (CaO)—the lime (CaO) chemically reacts with CO₂ to form Calcium Carbonate (CaCO₃) which will increase the YP; and low temperature—in an oil-based system, the low temperature increases the viscosity and the YP.

According to some embodiments of the technology herein presented, the aforesaid analysis system is utilizable for determining one or more of the following (i) electrical stability (ES) and other oil based mud properties; (ii) methylene blue test (MBT) or a cation exchange capacity which is used to determine the amount of reactive clay (clay-like materials) in water-based mud; (iii) chloride content in the water-based mud, and potentially maintaining the chloride content in the drilling fluid by feedbackedly adding or otherwise admixing salts such as potassium chloride and sodium chloride; (iv) total hardness, or water hardness of water based mud, e.g., by measurement of calcium and magnesium ions in water-based mud, by e.g., titration with standard Vesenate solution; (v) solubility of drilling mud and Spud Mud (water based mud); (vi) saturation and free water of drilling mud. Most drilling mud chemicals can be dissolved into the liquid phase until they reach a maximum solubility limit, namely their saturation point. Soluble solid will stop dissolving into the liquid phase when it reaches the saturation point; (vii) oil-water ratio (OWR); (viii) alkalinity or excess lime; (viii) phenolphthalein alkalinity of the mud filtrate (PM) or methyl orange alkalinity end point of mud filtrate (MF); (ix) in oil based mud, determining calcium chloride profile (content over time) to indicate possible calcium chloride contamination; thereby feedbackedly operating in one or more of the following steps: (a) adding more viscosifier(s) to improve the overall emulsion, e.g., whilst testing electrical stability (ES); (b) adding more lime, since oil and water will mix together well if the water is sufficiently basic, addition of lime will increase alkalinity of the mud and improve the emulsion; (c) adding wetting agent; and/or (d) diluting the system with fresh water to reduce overall chloride concentration and adding emulsifiers to improve mud emulsion; (e) gas solubility in oil based mud; (f) detecting and avoiding gas kicking, by treating problems of insufficient mud weight, improper hole fill-up during trips, swabbing, cut mud and/or lost circulation; (g) due to gas solubility in the oil-based mud, continuously or periodically on-line determining mud profile, including concurrently performing steps of determining wellbore temperature, determining pressure in the well, determining type of base fluid used to make the mud, determining chemical composition of formation gas etc.; (h) determining characteristics of the drilling mud, thereby optimizing the drilling mud and operation of the solid control equipment, hence minimizing drilling waste; (i) equivalent circulating density (ECD)—where the ECD typically increases when the YP increases and hole cleaning—when the drill is characterized by a large diameter hole, the YP in the drilling mud should be higher in order to help hole cleaning efficiency, and (j) water phase activity of drilling mud. Water phase activity (WPA) is a relative measure of how easily water can evaporate from the drilling mud. WPA is onlinely measured, by means of said analysis system, by determining the fraction of water vapor in the air space of a closed container of liquid solution; the evaporation rate for pure water is larger than the evaporation rate for water containing dissolved salts; (k) rheological parameters; (l) salinity of the drilling fluid; (m) water cut, namely the ratio of water produced compared to the volume of total liquids produced. Water cut is determined by various means, such as radio or microwave frequency and NIR measurements, gamma ray based instruments etc. (n) flow parameters; and any combination thereof.

Additionally or alternatively, and according to yet another embodiment of the technology herein presented, the aforesaid analysis system can determine contaminants such as, but not limited to: (a) air, which can enter the top of the drill string during connection of a new section of drill pipe.; (b) pipe scale and pipe dope from inside the drill string; (c) rock sloughing or rubbing off formations up hole from the drill bit; (d) cuttings that have bedded or built up because of improper hole cleaning dynamics that are mobilized by changes in drilling fluid viscosity, pumping rate, or drill string or collar rotation; (e) uphole fluids that flow or are swabbed into the annulus; and any combination thereof.

It should be noted that additives in the drilling fluid such as weighting agents and lost-circulation material are not considered contaminants, but preferably are monitored because they can interfere with analytical observations and descriptions or give interfering instrument responses.

It should further be noted that some base fluids for drilling fluid, particularly some of the synthetic fluids, and some of the chemical additives can make it difficult to determine whether a chemical found in the drilling fluid is there intentionally, has entered the drilling fluid from the formation, or as a contaminant. As a non-limiting example, some sulfate or sulfonate wetting agents can give a false positive H₂S indication.

In some embodiments, the shape, size and porosity of the cuttings, along with analysis of their composition, the flow speed of the mud, as described hereinabove, and the depth of the hole, known from the length of the drill string, is used to generate a mud log on-line and in real time.

In embodiments of the present invention in which a mud log is generated, analysis of the rock fragments entrained in the drilling mud is done automatically, thereby ensuring that the analyzed fragments accurately represent the rock as cut.

In some embodiments, physical samples of the drilling fluid can be removed from the mud line for testing and verification purposes. Such physical samples can be collected either automatically, to a predetermined schedule, or on demand and, preferably, labeled automatically. The label preferably comprises a unique identifier, the time the physical sample was collected, and any combination thereof. The unique identifier, the time the physical sample was collected, and any combination thereof is preferably stored in a database. Other information recordable on the label and storable in the database includes, but is not limited to, the temperature of the fluid at the time of collection and the flow rate of the fluid at the time of collection.

In preferred embodiments, the device comprises a testing mode, in which a testing material of predetermined composition is run through the analysis system. The known composition can comprise predetermined fractions of solid, liquid and gas, with the solid, liquid and gas comprising predetermined materials. It can also comprise rock fragments, of a predetermined size distribution and a predetermined shape distribution, with the rock fragments comprising known materials of a known chemical composition. Comparison of the analysis system results with the predetermined composition enables calibration of the analysis system and thereby enables verification of the proper functioning of the analysis system.

In a preferred embodiments, the database is read-only.

In a preferred embodiments, only authorized personnel can operate the analysis system and, in variants of these embodiments, a higher level of authorization is needed in order to use the testing mode or calibration mode of the analysis system. Therefore, the accuracy of results generated by the system can be verified, and the results certified. Certification can be first party certification, wherein the mud engineer does the testing and certifies the results, or it can be third-party certification, wherein an employee of a testing company or testing organization does the testing and certifies the results. The results of the analyses can be validated, both as to the at least one parameter determined and, in some embodiments, as to the underground location to which the results refer. The database (and the mud log) can provide a specification for the formation since, as described hereinabove, the accuracy of the data is verifiable.

Furthermore, in addition to controlling the mud characteristics via a feedback mechanism, the present invention can provide a specification as a function of time of at least one characteristic of the drilling fluid such as, but not limited to, the fluid's rheology, rheometry, density, salinity, water cut, and contaminant fraction.

I claim:

1. An integrated multimodality system for analyzing and monitoring drilling mud recycling, said multimodality system comprises:
an integrated multimodality analyzing module coupled to a drilling mud recirculation system; and
at least one processing module configured to receive in real time at least one result of measurement from said integrated multimodality analyzing module, to report in real time said at least one result, to compare in real time said at least one result with an established standard, and to communicate with at least one feedback mechanism for automatic control of at least one step of drilling mud recycling process;
wherein said integrated multimodality analyzing module comprises at least two analyzing means configured to measure independently at least one physical or chemical property of said drilling mud and is configured to measure in real time at least one chemical or physical property of said drilling mud flowing through said drilling mud recirculation system.

2. The multimodality system according to claim 1, wherein said analyzing means comprising at least one member of the group consisting of nuclear magnetic resonance (NMR), magnetic resonance imaging (MRI), dynamic imaging particle analyzer, gas chromatography (GC), liquid chromatography (LC), high performance liquid chromatography (HPLC), laser diffraction, mass spectrometry (MS), FTIR spectrometry gas analyzer, atomic absorption spectroscopy (AAS), Infrared Spectroscopy (IR), differential scanning calorimetry (DSC), electron paramagnetic resonance (EPR), energy dispersive spectroscopy (EDS), field flow fractionation (FFF), flow injection analysis (FIA), gel permeation chromatography-IR spectroscopy (GPC-IR), Mossbauer spectrometer, ion microprobe (IM), inductively coupled plasma (ICP), ion selective electrode (ISE), laser induced breakdown spectroscopy (LIBS), neutron activation analysis, particle induced X-ray emission spectroscopy (PIXE), pyrolysis gas chromatography mass spectrometry (PY-GC-MS), Raman spectroscopy, refractive index, resonance enhanced multiphoton ionization (REMPI), thermogravimetric Analysis (TGA), X-ray diffraction (XRD), X-ray fluorescence spectroscopy, X-ray microscopy, pressure sensor, differential pressure sensor, salinity sensor, densitometer, CO₂ concentration analyzer, Pipe or Capillary rheometers, Rotational cylinder rheometers, extensional rheometers, Acoustic rheometers, Falling Plate rheometers, Capillary or Contraction Flow rheometers, Oscillating Disc Rheometer (ODR), Moving Die Rheometer (MDR), U-tube viscometers, Falling sphere viscometers, Oscillating Piston Viscometer, Vibrational viscometers, Rotational viscometers, Electromagnetically Spinning Sphere, Viscometer, Stabinger viscometer, Bubble viscometer, Micro-Slit Viscometers, Mooney-Line viscometer and any combination thereof.

3. The multimodality system of claim 1, wherein said at least one physical or chemical property provided by said analyzing means is selected from the group consisting of: specific gravity, density, salinity, rheology parameter, particle size, particle radius, particle size distribution, particle radius distribution, particle shape, particle shape distribution, particle smoothness, particle roughness, particle smoothness to roughness distribution, particle ruggedness, particle gruffness, particle choppedness, particle granulation, particle raggedness, particle raucousness, particle rustication (scabrousness), water content, content of water-immiscible solutions, water to solvent ratio, electrical stability, cation exchange capacity, chloride content in water based mud, water hardness in water based mud, solubility of water based mud, saturation of water based mud, alkalinity, phenophthalein alkalinity of mud filtrate, methyl orange alkalinity end point of mud filtrate, calcium chloride content; gas solubility in oil based mud, chemical composition of formation gas, equivalent circulating density, water phase activity, salinity of said drilling mud, water cut, flow parameters, and any combination thereof.

4. The multimodality system according to claim 1, wherein said drilling mud recirculation system comprises:
a drilling mud recycling unit;
at least one conduit in fluid communication with said drilling mud recycling unit, said conduit comprises a mud-inflow and a mud-outflow in fluid communication with a drilling rig; and
at least one pump for in fluid communication with said conduit configured to produce an internal flow of drilling mud through said conduit from said mud-inflow to said mud-outflow.

5. The multimodality system according to claim 4, wherein said drilling mud recycling unit comprising at least one member selected from the group consisting of means to restore physical properties of said drilling mud, means to restore chemical properties of said drilling mud, shale shaker, at least one reservoir of drilling mud in closable connection with said internal flow and any combination thereof.

6. The multimodality system according to claim 1, wherein said processing module comprising communication component, a non-transitory computer-readable medium and a display.

7. The multimodality system according to claim 1, wherein said feedback mechanism comprises the group consisting of recirculation control system, a receiving station not connected to said recirculation system or any combination thereof.

8. The multimodality system according to claim 1, wherein said recirculation system further comprising:
a tank configured to hold spent drilling fluid;
a density separation device coupled to an outlet of the tank, said density separation device providing an overflow stream and an underflow stream containing denser material than said overflow stream; and
a fluid density control system configured to adjust the density of the spent drilling fluid provided to the density separation device by recirculating a portion of said underflow stream into said tank.

9. The multimodality system according to claim 1, wherein said system generates a mud log, parameters in said mud log selected from a group consisting of: drill rate, particle size, particle shape, particle size distribution, particle shape distribution, lithology of the stratum being drilled, mineralogical description of the stratum being drilled, porosity of the stratum being drilled, mud volume, pump weight, pump pressure, outlet pressure, and any combination thereof.

10. The multimodality system according to claim 1, wherein said multimodality system is portable either in or on a vehicle.

11. The multimodality system according to claim 1, wherein at least one of the following is true:
at least a part of said drilling mud recirculation system is configured to comply with a NeSSI specification;
at least a part of said drilling mud recirculation system is configured to comply with ANSI/ISA SP76.00.2002 miniature, modular mechanical standard specifications; and
said drilling mud recirculation system comprises a NeSSI communication bus.

12. The multimodality system according to claim 4, wherein said integrated multimodality analyzing module is configured to generate at least one rheological parameter of said drilling mud from at least one radial velocity profile.

13. The multimodality system according to claim 1, wherein said processing module determines and evaluates at least one quality test parameter Q_{T} following steps of:
defining a quality parameter Q=\sqrt{k²+n²}, where k and n are determined from a relation τ(r)=k[γ(r)]ⁿ, where τ(r) is a radial shear stress of said drilling mud flowing through said conduit and γ(r) is a radial shear rate distribution of said drilling mud flowing through said conduit;
acquiring a standard quality parameter Q_{S}=\sqrt{k_{S}²+n_{S}²} from analysis of a standardized sample of said drilling mud, said analysis of said standardized sample generating standardized stress parameters k_{S} and n_{S} in the power law equation σ_{S}(r)=k_{S}[γ_{S}(r)]ⁿ^{_{S}} from rheological parameters standardized radial shear stress parameter σ_{S}(r) and standardized radial shear rate parameter γ_{S}(r);
acquiring a composition quality parameter Q_{C}=\sqrt{k_{C}²+n_{C}²} from analysis of a sample of said drilling mud, said analysis of said sample generating composition stress parameters k_{C} and n_{C} in the power law equation σ_{C}(r)=k_{C}[γ_{C}(r)]ⁿ^{_{C}} from rheological parameters composition radial shear stress parameter σ_{C}(r) and composition radial shear rate parameter γ_{C}(r); and
determining the quality test parameter Q_{T}=|Q_{S}−Q_{C}|.

14. The multimodality system according to claim 13, wherein if said at least one quality test parameter Q_{T} fails to meet said quality criterion, then
notifying said feedback mechanism via said processing module to activate said recycling unit to perform at least one predetermined action; and
performing said at least one action until said measured value meets said quality criterion.

15. An integrated method for analyzing and monitoring drilling mud recycling process, said method comprises the steps of:
providing an integrated multimodality analyzing module coupled to a drilling mud recirculation system;
providing at least one processing module;
measuring in real time at least one chemical or physical property of drilling mud flowing through said recirculation system using said integrated multimodality analyzing module;
receiving in real time at least one result of said measurement from said integrated multimodality analyzing module via said processing module;
reporting in real time at least one result of said measurement or comparing in real time at least one result of said measurement with an established standard via said processing module; and
communicating via said processing module with at least one feedback mechanism for automatic control of at least one step of drilling mud recycling process;
wherein said integrated multimodality analyzing module comprises at least two analyzing means configured to measure independently at least one physical or chemical property of said drilling mud and is configured to measure in real time at least one chemical or physical property of said drilling mud flowing through said drilling mud recirculation system.

16. The integrated method according to claim 15, wherein said analyzing means comprising at least one member of the group consisting of nuclear magnetic resonance (NMR), magnetic resonance imaging (MRI),dynamic imaging particle analyzer, gas chromatography (GC), liquid chromatography (LC), high performance liquid chromatography (HPLC), laser diffraction, mass spectrometry (MS), FTIR spectrometry gas analyzer, atomic absorption spectroscopy (AAS), Infrared Spectroscopy (IR), differential scanning calorimetry (DSC), electron paramagnetic resonance (EPR), energy dispersive spectroscopy (EDS), field flow fractionation (FFF), flow injection analysis (FIA), gel permeation chromatography-IR spectroscopy (GPC-IR), Mossbauer spectrometer, ion microprobe (IM), inductively coupled plasma (ICP), ion selective electrode (ISE), laser induced breakdown spectroscopy (LIBS), neutron activation analysis, particle induced X-ray emission spectroscopy (PIXE), pyrolysis gas chromatography mass spectrometry (PY-GC-MS), Raman spectroscopy, refractive index, resonance enhanced multiphoton ionization (REMPI), thermogravimetric Analysis (TGA), X-ray diffraction (XRD), X-ray fluorescence spectroscopy, X-ray microscopy, pressure sensor, differential pressure sensor, salinity sensor, densitometer, CO₂ concentration analyzer, U-tube viscometers, Falling sphere viscometers, Oscillating Piston Viscometer, Vibrational viscometers, Rotational viscometers, Electromagnetically Spinning Sphere, Viscometer, Stabinger viscometer, Bubble viscometer, Micro-Slit Viscometers, Mooney-Line viscometer, Pipe or Capillary rheometers, Rotational cylinder rheometers, extensional rheometers, Acoustic rheometers, Falling Plate rheometers, Capillary/Contraction Flow rheometers, Oscillating Disc Rheometer (ODR), Moving Die Rheometer (MDR) and any combination thereof.

17. The integrated method according to claim 15, wherein said at least one physical or chemical property analyzed by said analyzing means is selected from a group consisting of: specific gravity, density, salinity, rheology parameter, particle size, particle radius, particle size distribution, particle radius distribution, particle shape, particle shape distribution, particle smoothness, particle roughness, particle smoothness to roughness distribution, particle ruggedness, particle gruffness, particle choppedness, particle granulation, particle raggedness, particle raucousness, particle rustication (scabrousness), water content, content of water-immiscible solutions, water to solvent ratio, electrical stability, cation exchange capacity, chloride content in water based mud, water hardness in water based mud, solubility of water based mud, saturation of water based mud, alkalinity, phenophthalein alkalinity of mud filtrate, methyl orange alkalinity end point of mud filtrate, calcium chloride content; gas solubility in oil based mud, chemical composition of formation gas, equivalent circulating density, water phase activity, salinity of said drilling mud, water cut, flow parameters, and any combination thereof.

18. The integrated method according to claim 15, wherein said recycling system comprises:
a drilling mud recycling unit;
at least one conduit in fluid communication with said drilling mud recycling unit, said conduit comprises a mud-inflow and a mud-outflow in fluid communication with a drilling rig; and
at least one pump for in fluid communication with said conduit configured to produce an internal flow of drilling mud through said conduit from said mud-inflow to said mud-outflow.

19. The integrated method according to claim 15, wherein said recirculation system further comprising:
a tank configured to hold spent drilling fluid;
a density separation device coupled to an outlet of the tank, said density separation device providing an overflow stream and an underflow stream containing denser material than said overflow stream; and
a fluid density control system configured to adjust the density of the spent drilling fluid provided to the density separation device by recirculating a portion of said underflow stream into said tank.

20. The integrated method according to claim 15, wherein at least one of the following is true:
at least a part of said drilling mud recirculation system is configured to comply with a NeSSI specification;
at least a part of said drilling mud recirculation system is configured to comply with ANSI/ISA SP76.00.2002 miniature, modular mechanical standard specifications; and
said drilling mud recirculation system comprises a NeSSI communication bus.

21. The integrated method according to claim 15, wherein said step of measuring is carried out through said integrated multimodality analyzing module configured to generate at least one rheological parameter of said drilling mud from at least one radial velocity profile.

22. The integrated method according to claim 15, wherein at least one quality test parameter is determined following steps of:
defining a quality parameter Q=\sqrt{k²+n²}, where k and n are determined from a relation τ(r)=k[γ(r)]ⁿ, where τ(r) is a radial shear stress of said drilling mud flowing through said conduit and γ(r) is a radial shear rate distribution of said drilling mud flowing through said conduit;
acquiring a standard quality parameter Q_{S}=\sqrt{k_{S}²+n_{S}²} from analysis of a standardized sample of said drilling mud, said analysis of said standardized sample generating standardized stress parameters k_{S} and n_{S} in the power law equation σ_{S}(r)=k_{S}[γ_{S}(r)]ⁿ^{_{S}} from rheological parameters standardized radial shear stress parameter σ_{S}(r) and standardized radial shear rate parameter γ_{S}(r);
acquiring a composition quality parameter Q_{C}=\sqrt{k_{C}²+n_{C}²} from analysis of a sample of said drilling mud, said analysis of said sample generating composition stress parameters k_{C} and n_{C} in the power law equation σ_{C}(r)=k_{C}[γ_{C}(r)]ⁿ^{_{C}} from rheological parameters composition radial shear stress parameter σ_{C}(r) and composition radial shear rate parameter γ_{C}(r); and
determining the quality test parameter Q_{T}=|Q_{S}−Q_{C}|.

23. The integrated method according to claim 22, wherein if said at least one quality test parameter Q_{T} fails to meet said quality criterion, then said method comprises additional steps of:
notifying said recirculation control system via said processing module to activate said recycling unit to perform at least one predetermined action; and
performing said at least one action until said measured value meets said quality criterion.

24. A method of analyzing drilling parameters, comprising:
at least one step of analyzing comprising imaging and timing a series of NMR/MRI images of drilling mud before mud's re-used in a drilling hole (T_{influx});
either continuously of batch-wise flowing said time-resolved imaged drilling mud within said drilling hole whilst drilling said hole;
after flowing period, at least one step of imaging and timing a series of NMR/MRI images of drilling mud after the use in a drilling hole (T_{outflow}); and
comparing at least one parameter of said inflowing mud (timed at T_{influx}) and said outflowing mud timed (timed at T_{outflow}); thereby defining the change of said parameter and analyzing parameters related with the drilling.

25. The method according to claim 24, wherein said step of comparing at least one parameter of said inflowing mud (timed at T_{influx}) and said outflowing mud timed (timed at T_{outflow}) further comprising step of measuring the relaxation time T1, T2 and diffusion coefficient D.
